(19) United States
(12) Patent Application Publication
(10) Pub. No.: US 2011/0019080 A1
(43) Pub. Date: Jan. 27, 2011

(54) IMAGE CAPTURING DEVICE WITH PROTECTION FOR A LENS MODULE AND A DISPLAY SCREEN THEREOF

(76) Inventor: HSIN-YUN LIN, Taichung (TW)

Correspondence Address: TROP, PRUNER & HU, P.C., 1616 S. VOSS ROAD, SUITE 750, HOUSTON, TX, 77057-2631, US

(21) Appl. No.: 12/566,888

(22) Filed: Sep. 25, 2009

(30) Foreign Application Priority Data
Jul. 24, 2009 (TW) 098125011

(51) Int. Cl. H04N 5/225

(52) U.S. Cl. 348/376; 348/E05.022

(57) ABSTRACT

An image capturing device includes a first device body and a second device body. The first device body includes a first front surface, a first rear surface, and a lens module disposed at the first front surface. The second device body is disposed rotatably in front of the first device body, and includes a second front surface, a second rear surface, and a display screen disposed at the second rear surface. The second device body is rotatable relative to the first device body between a deactivated state and an activated state. The display screen and the lens module are covered by the first front surface and the second rear surface respectively when the second device body is in the deactivated state, and are uncovered by the first front surface and the second rear surface respectively when the second device body is in the activated state.

### CROSS-REFERENCE TO RELATED APPLICATION

This application claims priority of Taiwanese Application No. 098125011, filed on Jul. 24, 2009.

### BACKGROUND OF THE INVENTION

1. Field of the Invention

The present invention relates to an image capturing device, more particularly to an image capturing device with protection for a lens module and a display screen thereof.

2. Description of the Related Art

A conventional camera includes a device body, a lens module disposed at a front side of the device body, and a display screen disposed at a rear side of the device body. When the camera is in use, an image captured via the lens module is displayed on the display screen, which is convenient for a user to observe and to take a picture.

When the camera is not in use, a lens cap can be used for protecting the lens module. However, the display screen is still exposed and is likely to suffer from scratching. Therefore, it is necessary to place the camera in a camera case or bag for protection. Nevertheless, since the operation of shooting images often requires more time and is discontinuous, a user needs to take in and take out the camera from the camera case or bag repeatedly. This process is not only inconvenient to a user, but further increases the risk of scratching the display screen.

### SUMMARY OF THE INVENTION

Therefore, the object of the present invention is to provide an image capturing device with protection for a lens module and a display screen thereof.

Accordingly, an image capturing device of the pre sent invention comprises a first device body and a second device body. The first device body includes a first front surface, a first rear surface disposed opposite to the first front surface, and a lens module disposed at the first front surface. The second device body is disposed rotatably in front of the first device body, and includes a second front surface, a second rear surface disposed opposite to the second front surface, and a display screen disposed at the second rear surface. The second device body is rotatable relative to the first device body between a deactivated state and an activated state. The display screen and the lens module are covered by the first front surface and the second rear surface respectively when the second device body is in the deactivated state, and are uncovered by the first front surface and the second rear surface respectively when the second device body is in the activated state.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a preferred embodiment of an image capturing device according to the present invention;

FIG. 2 is a front view of the image capturing device of the preferred embodiment to illustrate a second device body in an activated state;

FIG. 3 is a rear view of the image capturing device of the preferred embodiment to illustrate the second device body in the activated state;

FIG. 4 is a front view of the image capturing device of the preferred embodiment to illustrate the second device body in a deactivated state;

FIG. 5 is a sectional view of the image capturing device of the preferred embodiment taken along line V-V in FIG. 4;

FIG. 6 is a front view of the image capturing device of the preferred embodiment to illustrate rotation of the second device body relative to a first device body; and

FIG. 7 is a circuit block diagram of the image capturing device of the preferred embodiment.

### DETAILED DESCRIPTION OF THE PREFERRED EMBODIMENT

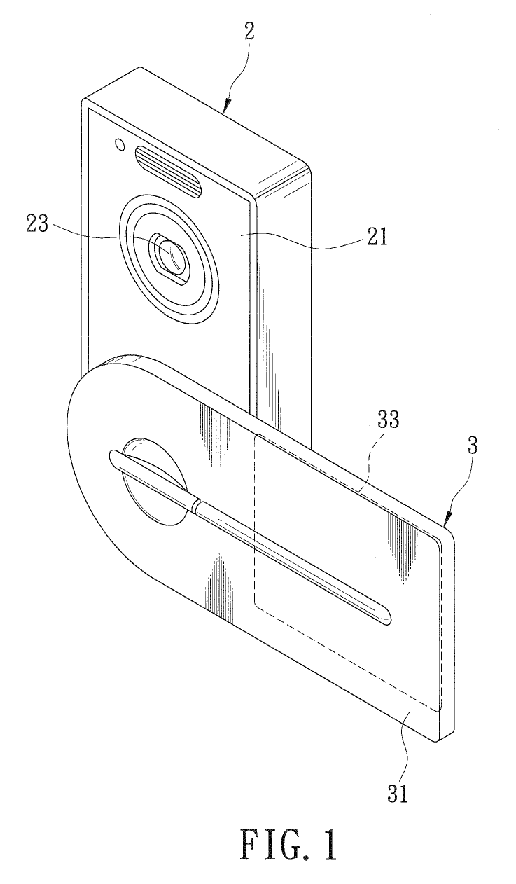

Referring to FIGS. 1, 3, and 5, a preferred embodiment of an image capturing device according to the present invention is shown to comprise a first device body 2, a second device body 3, a pivoting unit 4, a limiting unit 5, an operating key set 6, an image sensor 7, and a control unit 8.

Referring to FIGS. 1, 2, and 3, the first device body 2 includes a first front surface 21, a first rear surface 22 disposed opposite to the first front surface 21, and a lens module 23 disposed at the first front surface 21. In this embodiment, the lens module 23 is a telescopic lens movable along a front/back direction, but may be a fixed focus lens in other embodiments.

The second device body 3 is disposed rotatably in front of the first device body 2, and includes a second front surface 31, a second rear surface 32 disposed opposite to the second front surface 31, and a display screen 33 disposed at the second rear surface 32. In this embodiment, the display screen 33 is a liquid crystal display (LCD) screen.

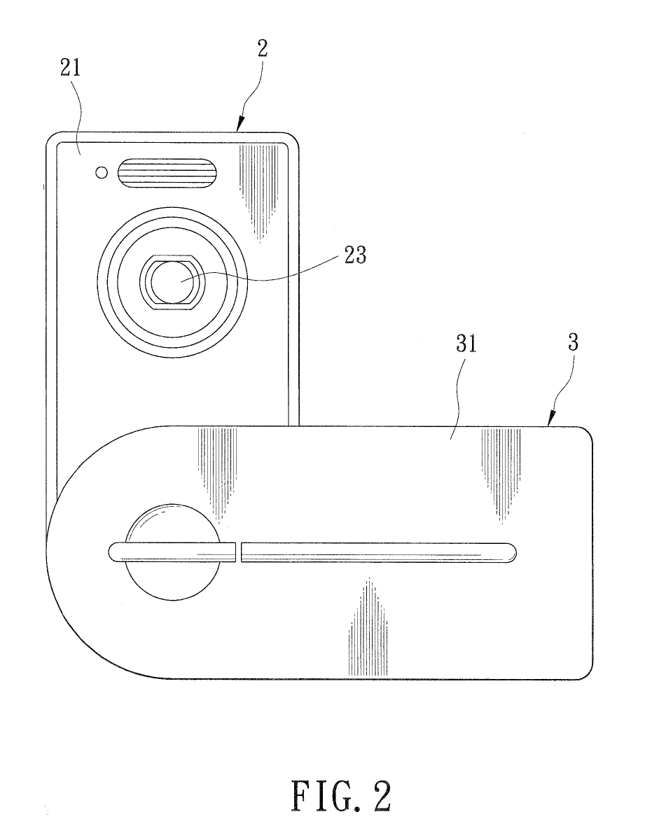

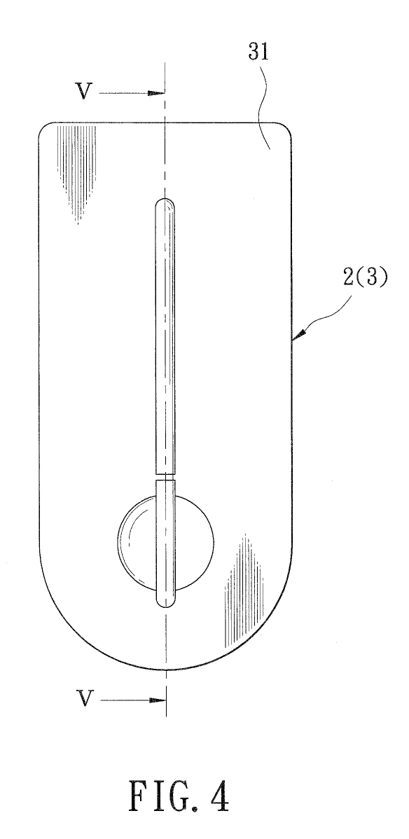

Referring to FIGS. 2, 3, and 4, the second device body 3 is rotatable relative to the first device body 2 between a deactivated state and an activated state. The display screen 33 and the lens module 23 are covered by the first front surface 21 and the second rear surface 32 respectively when the second device body 3 is in the deactivated state, and are uncovered by the first front surface 21 and the second rear surface 32 respectively when the second device body 3 is in the activated state.

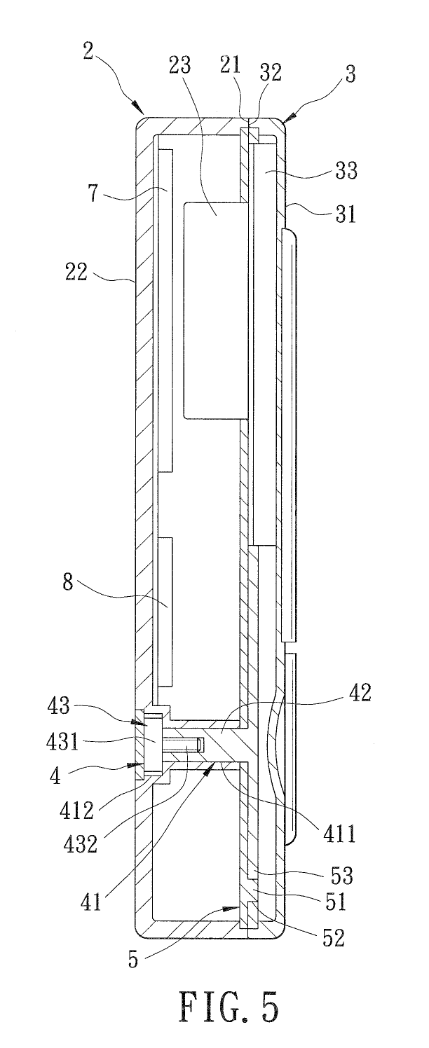

Referring to FIG. 5, the pivoting unit 4 includes a hole portion 41 that is provided in the first front surface 21 and that extends to the first rear surface 22, an axle 42 that is disposed on the second rear surface 32 and that extends rotatably into the hole portion 41, and a connecting component 43 that interconnects the first device body 2 and the axle 42 along a direction of extension of the axle 42. When the axle 42 is rotated, the second device body 3 is also rotated relative to the first device body 2.

The hole portion 41 is provided with a counter bored hole, which has a small diameter portion 411 adjacent to the first front surface 21 for inserting the axle 42, and a large diameter portion 412 adjacent to the first rear surface 22. In this embodiment, the connecting component 43 is a screw, which has a head portion 431 disposed in the large diameter portion 412, and a fixing portion 432 extending from the head portion 431 and into the small diameter portion 411 so as to lock the axle 42 on an end portion adjacent to the first rear surface 22.

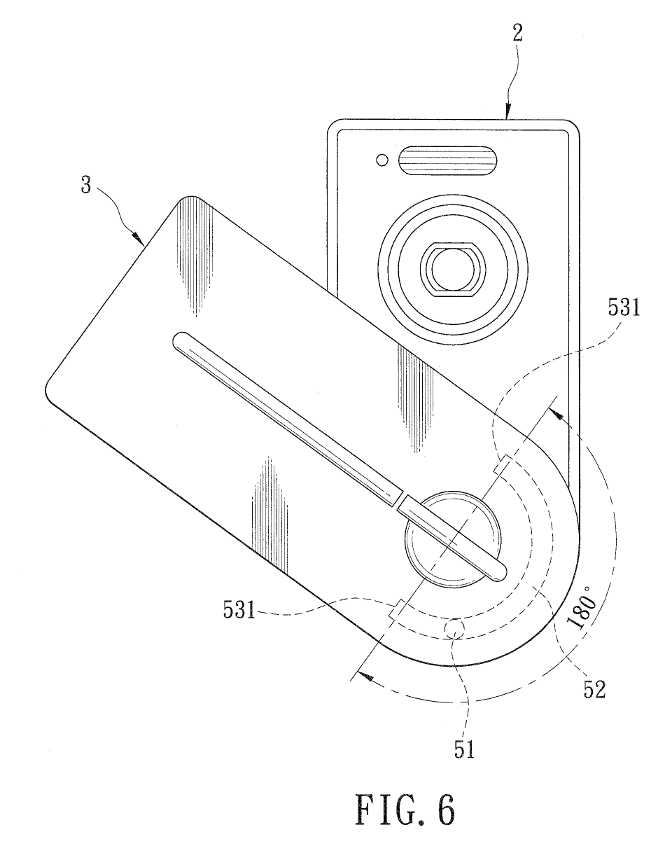

Referring to FIGS. 5 and 6, the limiting unit 5 includes a stop pin 51 that extends from the first front surface 21 toward the second device body 3, and a surrounding wall 53 that is disposed on the second device body 3 and that defines a curved groove 52. The curved groove 52 is formed in the second rear surface 32 and allows the stop pin 51 to move therein. The surrounding wall 53 has two stop faces 531 adjacent to two opposite ends of the curved groove 52 for blocking movement of the stop pin 51. The curved groove 52 in the second device body 3 allows the stop pin 51 on the first device body 2 to rotate relative to the second device body 3 within a 180-degree range.

When the second device body 3 rotates relative to the first device body 2 about the axle 42, the stop pin 51 moves along the curved groove 52, and is blocked by the stop faces 531, which allows the second device body 3 to rotate 90-degrees in a left or right direction for users having different habits of operating.

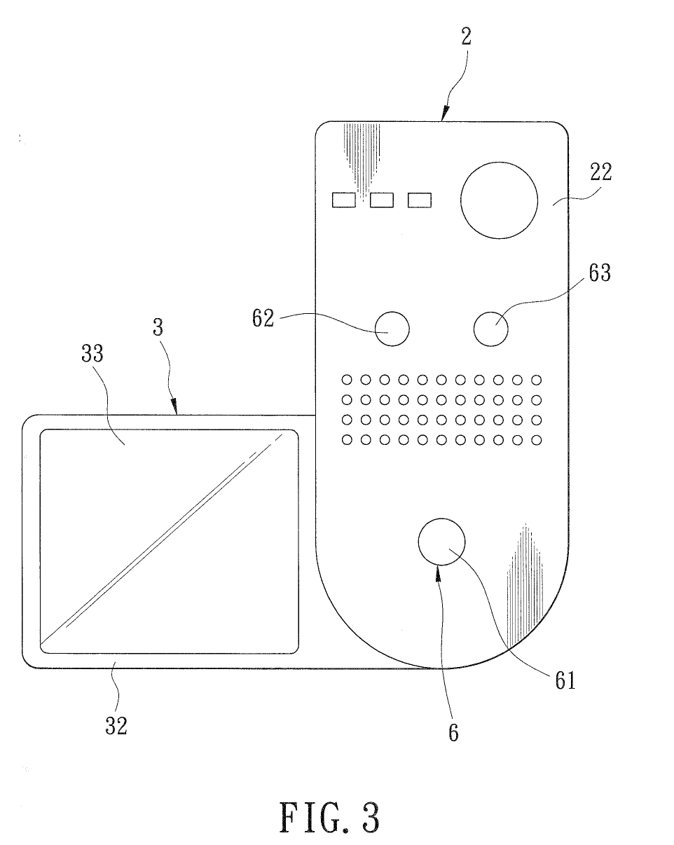

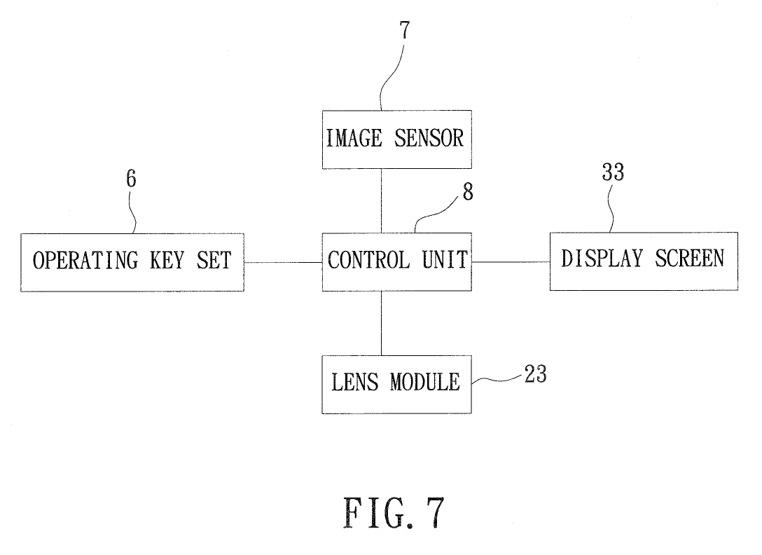

Referring to FIGS. 3 and 7, the operating key set 6 is electrically connected to the control unit 8, and includes a record button 61 disposed on the first rear surface 22, and zoom-in and zoom-out keys 62, 63 that are disposed on the first rear surface 22.

Referring to FIG. 5, an image sensor 7 is disposed in the first device body 2 for receiving an image via the lens module 23. The image sensor 7 may be a complementary metal-oxide semiconductor (CMOS) optical component, or a charge coupled device (CCD) optical component.

Referring to FIGS. 3, 5, and 7, the control unit 8 is electrically connected to the display screen 33 and the image sensor 7, the operating key set 6, and the lens module 23. The control unit 8 receives and processes a signal from the image sensor 7, and then outputs a processed signal to the display screen 33. In this embodiment, the control unit 8 further has functions for storing and outputting digital image data.

When the image capturing device is in use, the second device body 3 is rotated to the activated state for taking a picture. At this moment, an image is received through the lens module 23, and then processed by the image sensor 7 and the control unit 8 for subsequent display on the display screen 33. The zoom-in and zoom-out keys 62, 63 can be used to adjust a focal length of the lens module 23 and a size of the image on the display screen 33. The record button 61 is for taking a picture, and drives the control unit 8 for storing the picture.

After use, the second device body 3 may be rotated to the deactivated state for protecting the lens module 23 and the display screen 33.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An image capturing device comprising:
a first device body including a first front surface, a first rear surface disposed opposite to said first front surface, and a lens module disposed at said first front surface; and
a second device body that is disposed rotatably in front of said first device body, and that includes a second front surface, a second rear surface disposed opposite to said second front surface, and a display screen disposed at said second rear surface, said second device body being rotatable relative to said first device body between a deactivated state and an activated state, said display screen and said lens module being covered by said first front surface and said second rear surface respectively when said second device body is in the deactivated state, and being uncovered by said first front surface and said second rear surface respectively when said second device body is in the activated state.

2. The image capturing device as claimed in claim 1, further comprising an image sensor that is disposed in said first device body for receiving an image via said lens module, and a control unit electrically connected to said display screen and said image sensor, said control unit receiving and processing a signal from said image sensor and then outputting a processed signal to said display screen.

3. The image capturing device as claimed in claim 2, further comprising a pivoting unit, said pivoting unit including
a hole portion that is provided in said first front surface,
an axle that is disposed on said second rear surface, and that extends rotatably into said hole portion, and
a connecting component that interconnects said first device body and said axle along a direction of extension of said axle.

4. The image capturing device as claimed in claim 3, further comprising a limiting unit, said limiting unit including
a stop pin that extends from said first front surface toward said second device body, and
a surrounding wall that is disposed on said second device body and that defines a curved groove, said curved groove being formed in said second rear surface and allowing said stop pin to move therein, said surrounding wall having two stop faces adjacent to two opposite ends of said curved groove for blocking movement of said stop pin.

5. The image capturing device as claimed in claim 4, wherein said curved groove in said second device body allows said stop pin on said first device body to rotate relative to said second device body within a 180-degree range.

6. The image capturing device as claimed in claim 4, further comprising an operating key set that is electrically connected to said control unit and that includes a record button disposed on said first rear surface.

7. The image capturing device as claimed in claim 6, wherein said operating key set further includes zoom-in and zoom-out keys that are disposed on said first rear surface.
